(19) United States
(12) Patent Application Publication
(10) Pub. No.: US 2025/0058345 A1
(43) Pub. Date: Feb. 20, 2025

(54) SPRAY MACHINE ALIGNMENT SYSTEMS AND METHODS

(71) Applicant: Crown Packaging Technology, Inc., Tinley Park, IL (US)

(72) Inventors: Stuart Monro, Wantage (GB); Nicholas Caunter, Wantage (GB); Fergus Marshall, Wantage (GB)

(73) Assignee: Crown Packaging Technology, Inc., Tinley Park, IL (US)

(21) Appl. No.: 18/808,747

(22) Filed: Aug. 19, 2024

Related U.S. Application Data
(60) Provisional application No. 63/533,614, filed on Aug. 19, 2023.

(51) Int. Cl. B05B 15/68; B05B 13/02

(52) U.S. Cl. CPC B05B 15/68; B05B 13/0278

(57) ABSTRACT

A system and method for aligning spray guns of a spray system includes a pair of adjustment mechanisms. A laser alignment system employs a target device.

### CROSS-REFERENCE TO RELATED APPLICATIONS

This application claims the benefit of Provisional U.S. Patent Application No. 63/533,614 filed Aug. 19, 2023, the disclosure of which is incorporated herein by reference in its entirety.

### TECHNICAL FIELD

The present invention relates to industrial spraying, and more particular to systems and methods for alignment of spray guns for coating the interiors of metal cans.

### BACKGROUND

Beverage cans are typically formed of a unitary, drawn and wall ironed can body having an open end, to which a can “end” is seamed after filling. Beverage can bodies and some food can bodies typically receive an internal protective coating, generally referred to a “lacquer,” in a spray operation. Upon filling the can with beverage or food contents, the coating provides a barrier between the metal material of the can body and the contents.

The can body of a “two-piece” can is a cylindrical body having a thin sidewall and a bottom, often domed, that is integral with the sidewall. Can bodies of two-piece cans are formed by punching a circular disc or blank from a metal sheet and then drawing the blank into a cup, ironing the sidewall of the cup by forcing the cup through a series of dies having decreasing diameter, and forming a dome on the bottom of the cup, and then forming a flange at the upper, open end of the can body. Can produced by this process are referred to “drawn and wall ironed” or DWI cans.

The can body of a “three piece” can includes a sidewall and a pair of ends enclosing the sidewall at its top and bottom. The sidewall is often formed by rolling a metal sheet into a cylinder and welding the edges of the sheet together. An end is then seamed onto one end. After filling, another end is seamed onto the open end of the can body to seal the can. A three piece can may be sprayed either before or after the bottom end is seamed onto the sidewall. The term “can body” as used herein refers to a DWI can body of a two-piece can (having an enclosed bottom integral with the sidewall), a three piece can body having one seamed-on end, and a sidewall of a three-piece can alone (that is, prior being joined to an end at either end).

Two-piece beverage cans, which are ubiquitous for containing beverages, most commonly have a diameter between 52 mm and 84 mm and a height between 88 mm and 204 mm. Three-piece cans are mainly used for the packaging of food products, and have a diameter between 52 mm and 153 mm and a height between 38 mm and 178 mm. Most beverage can bodies are formed of aluminum, and beverage can ends are formed of a higher grade aluminum alloy than the can bodies. Most food cans are formed from tin-coated steel referred to as tinplate.

Referring to FIG. 1, a conventional spray machine 110 includes an indexing turret 120, a spin assembly 130, a spray system 140, and a discharge turret 150. Turret 120 includes a starwheel 121. Unsprayed can bodies 99 are fed from infeed trackway 112 into pockets 124 of turret starwheel 121. Pockets 124 are spaced about the perimeter of indexing turret 120 such that can bodies 99 rotate about the center 122 of indexing turret 120. Can bodies 99 are held in position in their respective pockets 124 via vacuum chucks 126 (also referred to as spinner pads), which may hold the sidewalls of the cans via suction or vacuum pressure and/or hold the base (where present, such as in two piece cans) of the can body against vacuum chuck 126. Where the can bodies being sprayed are steel, they may be held in place, such as on spinner pads, magnetically. Vacuum chuck 126 and spin assembly 130 are illustrated together in FIG. 1, as in the embodiment of the figures they are conventional and aligned. Turret 120 may be a conventional turret for handling can bodies, as will be understood by persons familiar with can manufacturing and/or can spray coating. The reference number 120 is employed to refer to a complete turret assembly while only portions of the turret are shown in the figures.

The turret 120 indexes (that is, rapidly moves to a predetermined rotational position) to position two can bodies 99 relative to two, fixed spray guns 142 for applying the coating during a dwell period that is, a period in the turret's indexing cycle in which the turret is stationary. An indexing box (not shown in the figures, well known by persons familiar with spray coating) controls the starting and stopping of the indexing turret 120 via an internal cam, as is well-known in the art. During the dwell period, a drive belt 134 of spin assembly 130 engages each of the vacuum chucks 126 of the can bodies to rotate the can bodies 99 while they are positioned in front of the spray guns. Drive belt 134 is driven by motor 132 engaged with a chuck pulley 136 and an idler pulley 138.

Can bodies 99 in conventional spraying operations are often rotated at 2000-2750 rpm (revolutions per minute). This spinning rotation of the can body about its longitudinal axis—enhances uniformity of coating over the internal surface of the can body. For a typical can body rotating at 2400 rpm, three revolutions is often considered adequate for evenly applying lacquer in an appropriate quantity. The spraying time is approximately 100 ms (milliseconds). In many commercial embodiments, dwell period is longer than spray period because of a several milliseconds for turning the spray gun on and off. After the dwell period, the indexing box rapidly rotates the turret to advance the sprayed can body out of position relative to the spray gun(s) and moves the next unsprayed can body into position for spraying (described more fully below). The turret 120 then transfers the sprayed can bodies 99 onto discharge turret 150, which then transfers the can bodies 99 onto discharge trackwork 114 for transport to further manufacturing stages in the production line, such as necking and flanging operations.

The two spray guns 142 of spray system 140 are typically oriented such that one is directed to (that is, targeted to or aimed at) the can body sidewall and another directed to the base of the can body. The spray guns are held in position by a spray gun mount or spray gun support 144.

The second of the two spray guns is typically positioned downstream (that is, relative to the movement of can bodies on the turret 120) of the first spray gun. For each can body 99, the turret 120 indexes to position one of the can bodies in position to receive spray from the first (that it, upstream) gun. Upon completion of the dwell time, the turret indexes to advance the can body (at this point, only partially coated) in position to receive spray from the second gun, and to advance an uncoated can into position to receive spray from the first spray gun. In this configuration, the system applies coating to two can bodies (via the two spray guns) during any one dwell period of each spray machine. For three-piece cans that do not yet have a base seamed on, only the spray gun for coating the sidewall might be required. A prior art spray machine is disclosed in WO2014/147163, which is supplied by a sister company to the present Applicant.

Regulations and/or beverage or food company's standards mandate a minimum weight or thickness of the coating over essentially all of the interior metal surface. The coating must be able to withstand both the can manufacturing process and the can's subsequent use for the duration of its shelf life. For beverage and food cans, the coating must be non-toxic and non-tainting.

Prior art spray gun alignment methods often employed a template or a jig to position each spray gun at the proper position in space and directional or angular orientation. When changing the can size from one format to another, for example, from a 25 cl beverage can to a 50 cl beverage can, or from a standard height can to a taller can etc, each pair of spray guns 142 must be adjusted to ensure sufficient lacquer coverage on the inside wall. The incumbent technology requires the manual setting of two parameters: the X & Y distances (measured in mm) between the spray gun nozzle and the centre of the dome, and the angular position (measured in degrees) of the gun nozzle relative to the centre of the dome. The incumbent rotary mount is loosened from its secure operational state, and the angular position of the spray gun adjusted manually, whilst simultaneously adjusting the X-Y distances. This is carried out by the first operator, whilst a second operator then must (re)secure the mount (back) into its operational state. A quantity of cans is then run through the lacquer spray machine, visually inspected by the operator(s) for coverage, and the process of spray gun adjustment repeated iteratively, to the extent required. Failure to do so can lead to inadequate spray coverage, and ultimately customer complaints.

Spray coating machines are often provided in a bank of six to ten spray machines. The same spray gun setting process must then be carried out on every spray machine in the bank of spray machines, until ultimately all of the spray machines have been adjusted, ready for the new can format. This process is not only incredibly time consuming, and delays the restart of production, but it may also lead to inconsistencies in spray coverage from spray machine to spray machine. Each operator may have their own particular technique for setting up the spray guns, such that the process is not reproducible.

Furthermore, as the industry switches from solvent-based lacquers to water-based lacquers, the inventors have encountered that water-based lacquers require greater alignment precision and accuracy that solvent-based lacquers to meet industry specifications without using excess lacquer.

Also, the lacquer behaviour once sprayed onto the can interior is less predictable, resulting in greater variability in coverage, particularly from one spray machine to another. Sprayed cans exiting the spray machines located furthest away from the main conveyor in the bank of spray machines have a longer transit time than those cans exiting the more closely situated spray machines, thereby giving rise to more spread. Greater process control is therefore needed.

### SUMMARY

A system for aligning a spray gun comprises an alignment mechanism adapted for positioning a spray gun tip at a predetermined datum point. A corresponding method for repeatably aligning a spray gun of a lacquer spray machine in a can manufacturing line comprises the steps of: determining a datum reference point and determining an angular direction of the spray gun such that desired alignment of the spray gun is achieved, and recording alignment coordinates of at least the datum reference point. Subsequent alignment of the spray gun is achieved by resetting the spray gun to the alignment coordinates associated with the datum reference point.

The method may include the step of determining the datum reference point by the steps of (a) recording coordinates of the spray gun, (b) operating the spray gun to spray lacquer on an interior of a can body, (c) assessing characteristics of the lacquer coating on the interior of the can body, (d) adjusting position of the spray gun to improve the characteristics of the lacquer coating, and (e) repeating steps (a) through (d) until a desired alignment is achieved. And the method may include determining the angular direction of the spray gun by (f) adjusting angular direction of spray gun. And the method may include affixing the spray gun to a support in a desired angular direction, and/or determining a datum reference point of the spray gun by adjusting position of the spray gun via alignment screws.

A system for repeatably aligning a spray gun of a lacquer spray machine in a can manufacturing line comprises: a support structure fixed relative to a base of the lacquer spray machine, the support structure including a rail and a spray gun mount, a spray gun affixed to the spray gun mount; at least two linear drive assemblies adapted for moving the spray gun mount relative to a datum reference point associated with desired alignment of the spray gun; and an angular drive assembly adapted for moving the spray gun mount relative to a desired angular direction of the spray gun. Upon achieving alignment at the datum reference point via iterative operation of the linear drive assembly and the angular drive assembly, coordinates of the datum zero point may be recorded to enable subsequent alignment of the spray gun by locating the spray gun mount based on the coordinates. The rail may be any structural support. The linear drive may be of any type, such as a screw (such as an acme screw), rack and pinion, belt or other actuator, which may be actuated either manually (that is, by hand such as by a knob rotated by a user's hand) or via an electric motor of any typ.

The linear drive assembly may include at least two linear drives—a first one of the linear drives oriented for translating (that is, moving in straight line or linear direction, as distinguished from rotational movement) the spray gun mount in a first direction and a second linear drive oriented for translating the spray gun mount in a second direction that is orthogonal to the first direction. The rail may be angled relative to vertical such that the first and second linear drives are capable of positioning the spray gun mount in X-Y-Z coordinates.

The system may also include third linear drive assembly such that the first and second directions define a horizontal X-Y plane and the third linear drive is adapted for translating the spray gun mount in a vertical Z direction. The linear drives may be manual (that is, hand operated, such as physically by a user's hand) linear drive having a display indicating a position of the linear drive such that recording of the position from the display at the datum reference point enables subsequent alignment of the spray gun mount by resetting the linear drives to the recording position.

Each one of the linear drives may include an actuator for moving the linear drive, such that upon determining the datum reference point, a control system is adapted for sending a signal to the actuator to position the linear drive at the datum reference point to enable subsequent alignment of the spray gun.

The angular drive assembly may be or include a display, such as an analogue readout (for example, a dial indicator or marking like on a micrometer) indicating angular position of the angular drive, such that recording of the position from the display enables subsequent alignment of the spray gun mount by resetting the angular drives to the recorded position.

According to another aspect of the present disclosure, a system for aligning a spray gun support structure of a lacquer spray machine in a can manufacturing line may comprise: a support structure fixed relative to a base of the lacquer spray machine; a laser device being coupled to the support structure and capable of producing at least one laser line; and a target device mounted to a predetermined position on the lacquer spray machine. The target device preferably is positioned such that the at least one laser line impinges on the target device. Accordingly, positioning of the laser line indicates relative alignment of the target device relative to the target device. The laser line preferably is linear horizontal and/or vertical line. Other embodiments are contemplated—for example, the laser line may be a circle or other arcuate line.

The support structure may include a rail to which the laser device is coupled to via a bracket. The target device may include an outwardly convex dome surface adapted to receive impingement of the horizontal laser line and/or impingement of the vertical laser line.

In practice, for an embodiment of the system, a deviation from linearity of the horizontal laser line impinging on the dome surface indicates angular misalignment of the laser device relative to the target device and/or a deviation from linearity of the vertical laser line impinging on the dome surface indicates angular misalignment of the laser device relative to the target device. A deviation from linearity of the horizontal laser line indicates angular misalignment of the laser device about a horizontal axis and the deviation from the linearity of the vertical laser line indicates angular misalignment of the laser device. A deviation from an intersection of the horizontal laser line and the vertical laser line relative to a center of the dome indicates misalignment of the laser device relative to the dome in a plane perpendicular to a central axis (that is, an axis of the can body and/or target device).

According to another embodiment, the target device is a stepped device to include a base face, a neck, and a front face; the neck extending forward relative to the base face such that the front face is formed on a distal end of the neck. The front face is planar and the base face is planar and parallel to the front face such that a deviation from co-linearity of the horizontal laser line impinging on the base face relative to the horizontal laser line impinging on the front face indicates angular misalignment of the laser device relative to the target device and/or a deviation from co-linearity of the vertical laser line impinging on the base face relative to the vertical laser line impinging on the front face indicates angular misalignment of the laser device relative to the target device.

A deviation from an intersection of the horizontal laser line and the vertical laser line relative to a center of the front face indicates misalignment of the laser device relative to the target device in a plane perpendicular to a central axis (that is, an axis of the can body and/or target device).

A method for aligning a spray gun support structure of a lacquer spray machine in a can manufacturing line comprises the steps of: impinging at least one laser line from a laser device on a target device (defined in any of the claims above) that is positioned to receive impingement the at least one laser line, and adjusting position of a support structure holding the laser device based on linearity of the at least one laser line, and/or based on deviation of a center of the laser line (such as intersection of horizontal and vertical laser lines).

According to another embodiment, a system for aligning a spray gun of a lacquer spray machine in a can manufacturing line comprises: a support structure fixed relative to a base of the lacquer spray machine, the support structure including a rail and a spray gun mount; a datum fixture coupled to the spray gun mount; a laser device affixed to the datum structure; and a target device mounted to a predetermined position on the lacquer spray machine, the target device being positioned such that at least one laser line from the laser device impinges on the target device. The datum fixture and target device are configured to be replaceable with a spray gun fixture and whereby, upon the laser device being aligned with the target device, replacing the datum device with the spray gun fixture and the spray gun positions the spray gun in a desired predetermined position.

### BRIEF DESCRIPTION OF THE FIGURES

FIG. 1 is a schematic view of portions of a prior art lacquer spray machine;

FIG. 2 is a top perspective view of a spray assembly in position to spray the inside surfaces of cans;

FIG. 3 is a bottom perspective view of the spray assembly of FIG. 2;

FIG. 4 is a front view of the spray assembly of FIG. 2;

FIG. 5 is a top view of the spray assembly of FIG. 2;

FIG. 6 is a bottom view of the spray assembly of FIG. 2;

FIG. 7 is a top view of the spray assembly during an initial point of alignment, showing the spray gun oriented parallel to a beverage can longitudinal axis;

FIG. 8 is a top view of the spray assembly during alignment subsequent to the view shown in FIG. 7, showing the spray gun oriented at an angle relative to the longitudinal axis of the beverage can;

FIG. 9 is a top view of the spray assembly during alignment subsequent to the view shown in FIG. 8, showing the spray gun oriented at an angle relative to the longitudinal axis of the beverage can and the spray gun nozzle adjacent a lip of the beverage can;

FIG. 10 is an enlarged view of a portion of FIG. 9;

FIG. 11 is a top view of the spray assembly during alignment subsequent to the view shown in FIG. 9, showing the spray gun oriented at an angle relative to the longitudinal axis of the beverage can;

FIG. 12 is a top view of the spray assembly during alignment subsequent to the view shown in FIG. 11, showing the spray gun oriented at an angle relative to the longitudinal axis of the beverage can and the spray gun nozzle in a position ready for spraying, thus defining a datum position;

FIG. 13 is a perspective view of a system for aligning a support arm of the spray gun assembly;

FIG. 14 is an enlarged view of a portion of FIG. 13 illustrating a laser crosshair and a target dome about an axis X′;

FIG. 15 is an enlarged, partially transparent, perspective view of a first embodiment target device;

FIG. 15A is a side-by-side, partially transparent, perspective view of three embodiments of the target device;

FIG. 15B is a front view is the three embodiments of the target device, illustrating misalignment relative to the laser device,

FIG. 16 is a front view of the first embodiment target device in an aligned position relative to the laser device;

FIG. 17 is a front view of the first embodiment target device illustrating a one-degree misalignment relative to the laser device;

FIG. 18 is a front view of the first embodiment target device illustrating a two-degree misalignment relative to the laser device;

FIG. 19 is a front view of the first embodiment target device illustrating a five-degree misalignment relative to the laser device;

FIG. 20 is a front view of the first embodiment target device illustrating a ten-degree misalignment relative to the laser device;

FIG. 21 is an enlarged, partially transparent, perspective view of a second embodiment target device,

FIG. 22 is a front view of the second embodiment target device in an aligned position relative to the laser device,

FIG. 23 is a front view of the second embodiment target device illustrating a one-degree misalignment relative to the laser device;

FIG. 24 a front view of the second embodiment target device illustrating a ten-degree misalignment relative to the laser device;

FIG. 25 is a front view of a third embodiment target device in an aligned position relative to the laser device;

FIG. 26 is a front view of a third embodiment target device illustrating a one-degree misalignment relative to the laser device;

FIG. 27 is a top view of a datum fixture illustrating another system and method for aligning a spray gun assembly; and

FIG. 28 is a view of the spray gun assembly of FIG. 27 after the datum fixture has been replaced with the spray gun bracket.

### DETAILED DESCRIPTION

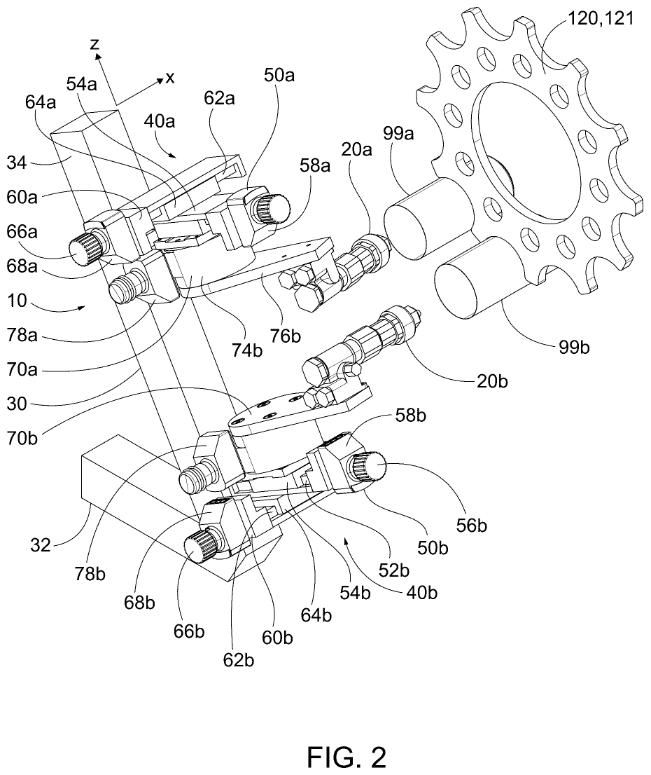

FIG. 2 illustrates an embodiment of a spray system 10 that includes a pair of spray gun assemblies 20a and 20b, a pair of alignment assemblies 40a and 40b and a support structure 30. The embodiment spray system 10 is illustrated in position for coating the inside surfaces of a pair of cans 99a and 99b. First can 99a is positioned relative to first spray gun assembly 20a and second can 99b is positioned relative to second spray gun assembly 20b.

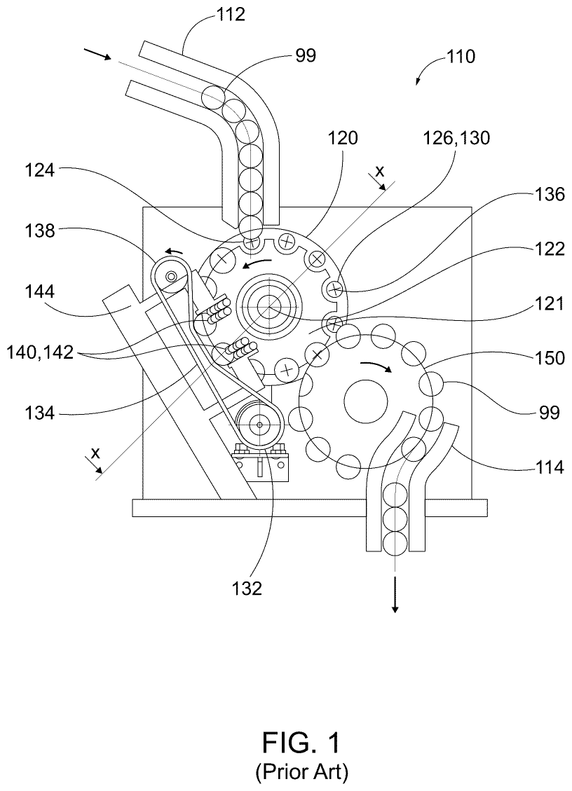

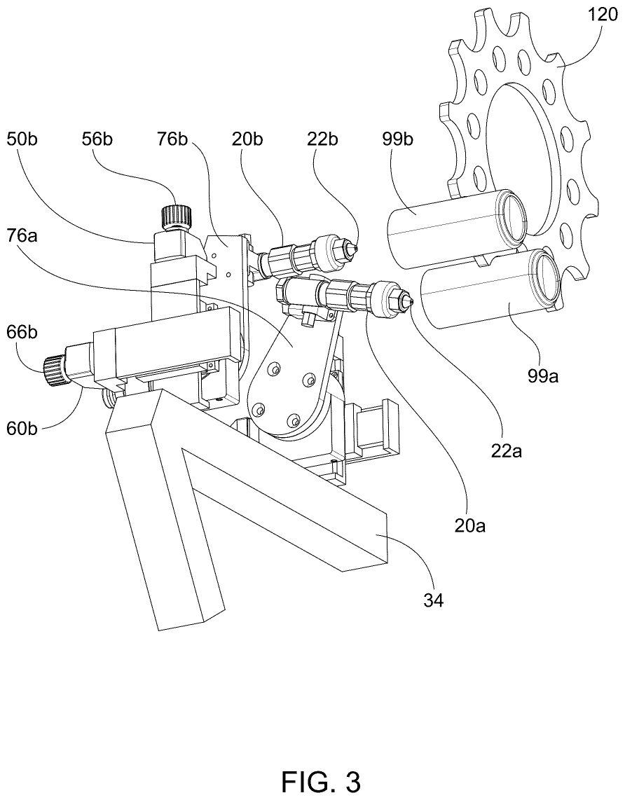

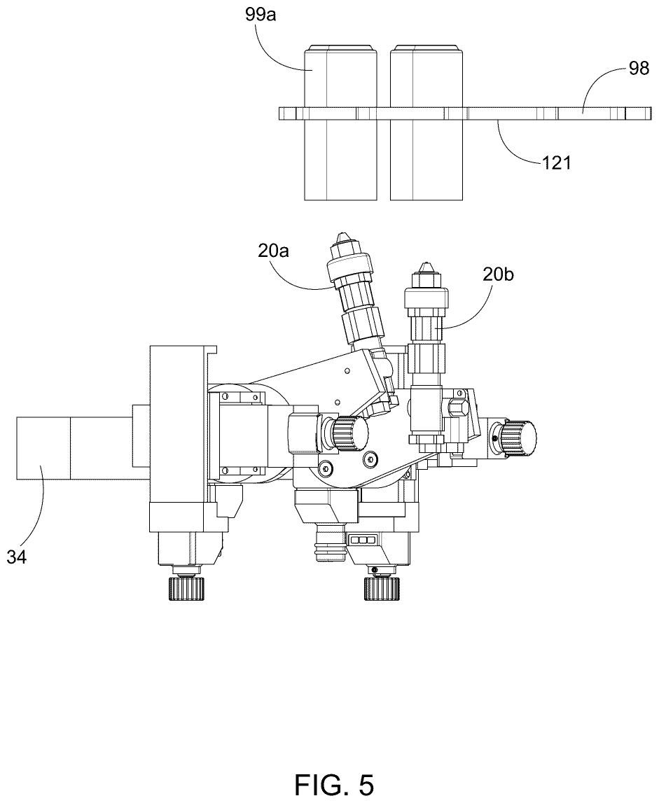

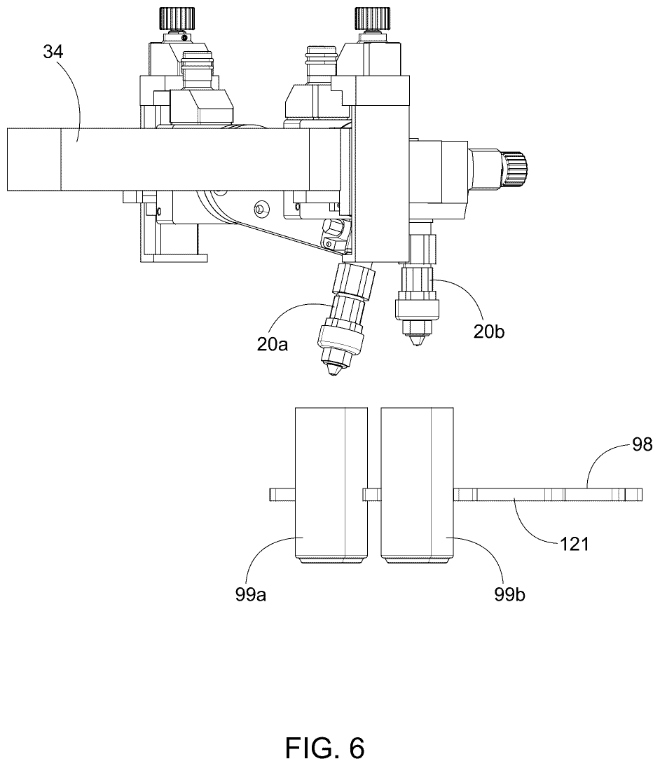

Cans 99a and 99b are held in corresponding pockets of indexing turret 120. It is understood that some portions of the can handling and indexing system are omitted from FIGS. 2 through 12 for clarity. For example, an inlet trackway, discharge turret, outlet trackway, can spin mechanism, and indexing mechanism, as well as a continuous line of cans, are omitted from the figures to enable clear views of spray system components. These and other portions omitted from the figures may be conventional, such as (without limitation) those as described in relation to FIG. 1 and/or as described in WO2016/193663, titled “Spray Coating of Cans,” which is from the same Applicant as the present invention.

Each spray gun assembly 20a and 20b may be a conventional gun that is commonly used for spraying a coating, such as a lacquer, in a beverage can or like manufacturing plant, as will be understood by persons familiar with can manufacturing technology. Spray gun assembly 20a includes a tip or nozzle 22a. Spray gun assembly 20b has a tip or nozzle 22b. Coating supply equipment is omitted for clarity. Each spray gun assembly 20a and 20b is oriented in a direction corresponding to its desired spray direction.

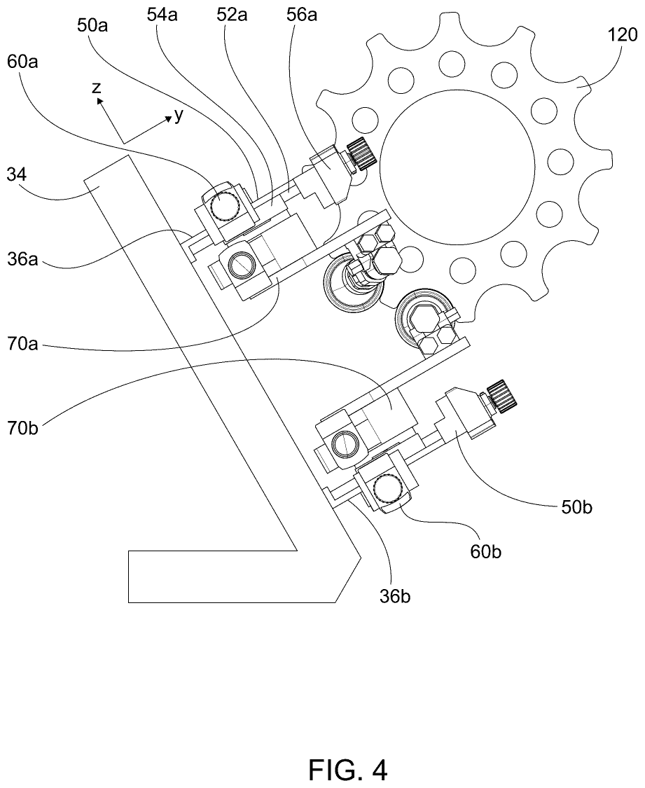

Support structure 30 includes a base 32 and an arm or rail 34. Base 32 may be affixed to the lacquer spray machine base or base 32 may have an independent support. Rail 34 extends upwardly from base 32 and, in the embodiment of the figures, provides a platform for supporting the alignment systems 40a and 40b. Coordinates axes are illustrated in FIGS. 2 and 4 for aiding in the description. Axis Z is parallel to the long axis of rail 34. Axes X and Y are perpendicular to axis Z. In the embodiment of the figures, axis Y is parallel to a plane defined by the starwheel face of indexing turret 120 and axis X is perpendicular to the indexing turret face. It is not required that rail 34 have an orientation regarding the axes described above. For any orientation of axes Y and Z movement along axis X may be considered generally to move closer or farther way from the cans to be coated.

Support structure 30 includes a pair of brackets 36a and 36b that are affixed to a face of the rail 34. In the embodiment of the figures, brackets 36a and 36b are rigidly affixed to rail 34, and the brackets 36a and 36b (as best shown in FIG. 4) may also be adapted to slide up and down in the Y direction, such as for coarse, manual adjustment.

An upper or first alignment assembly 40a includes a first Y-direction linear alignment mechanism 50a, a first X-direction linear alignment mechanism 60a, and a first angular alignment mechanism 70a.

First Y-direction linear alignment mechanism 50a includes a slider mechanism 52a, a carriage 54a, and an adjustment mechanism 56a. First Y-direction linear alignment mechanism 50a is oriented such that movement of the carriage 54a is along the Y-axis. The adjustment mechanism 56a may include a knob with a digital readout 58a to enable setting first Y-direction linear alignment mechanism 50a to its desired location, as explained below.

First X-direction linear alignment mechanism 60a includes a slider mechanism 62a, a carriage 64a, and an adjustment mechanism 66a. First X-direction linear alignment mechanism 60a is oriented such that movement of the carriage 64a is along the X-axis. Further, slider mechanism 62a is affixed to Y-direction carriage 54a such that the first X-direction linear alignment mechanism 60a is carried on the first Y-direction linear alignment mechanism 50a to enable movement in the X-Y plane. The adjustment mechanism 66a may include a knob with a digital readout 68a to enable setting first X-direction linear alignment mechanism 60a to its desired location.

First angular alignment mechanism 70a inclu12des a rotary alignment mechanism 74a and a gun mounting plate 76a that is mounted to the alignment mechanism 74a. The rotary alignment mechanism 74a provides pivoting or rotating movement relative to mounting plate 76a Further, first angular alignment mechanism 70a is affixed to the carriage 64a of first X-direction linear alignment mechanism 60a such that first angular alignment mechanism 70a may be positioned anywhere in the X-Y plane. The rotary alignment mechanism 74a may include a knob with a digital readout 78a to enable setting first angular alignment mechanism 70a to its desired location.

A lower or second alignment assembly 40b includes a second Y-direction linear alignment mechanism 50b, a second X-direction linear alignment mechanism 60b, and a second angular alignment mechanism 70b.

The second Y-direction linear alignment mechanism 50b includes a slider mechanism 52b, a carriage 54b, and an adjustment mechanism 56b. Second Y-direction linear alignment mechanism 50b is oriented such that movement of the carriage 54b is along the Y-axis. The adjustment mechanism 56b may include a knob with a digital readout 58b to enable setting second Y-direction linear alignment mechanism 50b to its desired location, as explained below.

Second X-direction linear alignment mechanism 60b includes a slider mechanism 62b, a carriage 64b, and an adjustment mechanism 66b. Second X-direction linear alignment mechanism 60b is oriented such that movement of the carriage 64b is along the X-axis. Further, slider mechanism 62b is affixed to Y-direction carriage 54b such that the second X-direction linear alignment mechanism 60b is carried on the second Y-direction linear alignment mechanism 50b to enable movement in the X-Y plane. The adjustment mechanism 66b may include a knob with a digital readout 68b to enable setting second X-direction linear alignment mechanism 60b to its desired location.

Second angular alignment mechanism 70b includes a rotary alignment mechanism 74b and a gun mounting plate 76b that is mounted to the rotary alignment mechanism 74b. The rotary alignment mechanism 74b provides pivoting or rotating movement relative to gun mounting plate 76b. Further, second angular alignment mechanism 70b is affixed to the carriage 64b of second X-direction linear alignment mechanism 60b such that second angular alignment mechanism 70b may be positioned anywhere in the X-Y plane. The rotary alignment mechanism 74b may include a knob with a digital readout 78b to enable setting second angular alignment mechanism 70b to its desired location.

First spray gun 20a is affixed to gun mounting plate 76a and second spray gun 20b is affixed to second gun mounting plate 76b.

Optionally, the manual (that is, by hand) knob adjustment device of the alignment mechanisms 50a, 60a, 70a, 50b, 60b, and 70b may be replaced or augmented with an actuator, such as a stepper motor, with an encoder capable of performing the registration function.

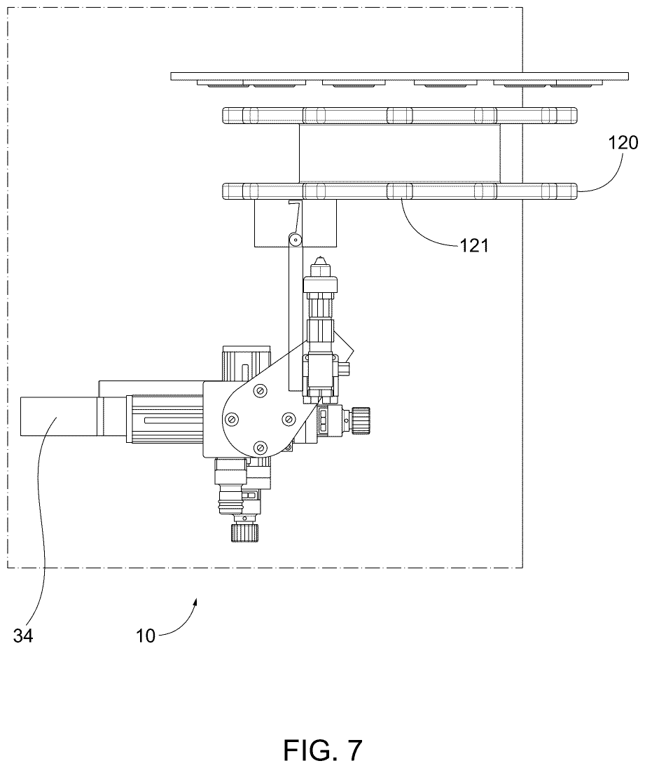

FIGS. 7 through 12 illustrate the alignment process of setting a process-based datum reference position for a spray gun assembly for spraying a beverage can sidewall. Spray gun 20a and its corresponding alignment and movement devices are employed for ease and clarity of description. Spray gun 20b is set in the same way as spray gun 20a, and therefore a repeat description is omitted for brevity. Thus, the second gun is aligned subsequent to the alignment of the first gun, while the support rail remains fixed.

FIG. 7 illustrates spray gun 20a in a retracted position and perpendicular to the face of starwheel 121. A protractor (or like reference tool) is placed against the surface of the starwheel 121 to confirm the perpendicular orientation of the spray gun 20a relative to the starwheel face 121 and therefore parallel to a can body centerline. In this regard, the face of turret starwheel 121 establishes a datum reference plane, which plane represents a plane perpendicular to a can longitudinal axis. An operator may set the digital readout 78a of the angular alignment mechanism 70a to zero at this point to indicate that the orientation of the gun is aligned with the longitudinal axis of the can.

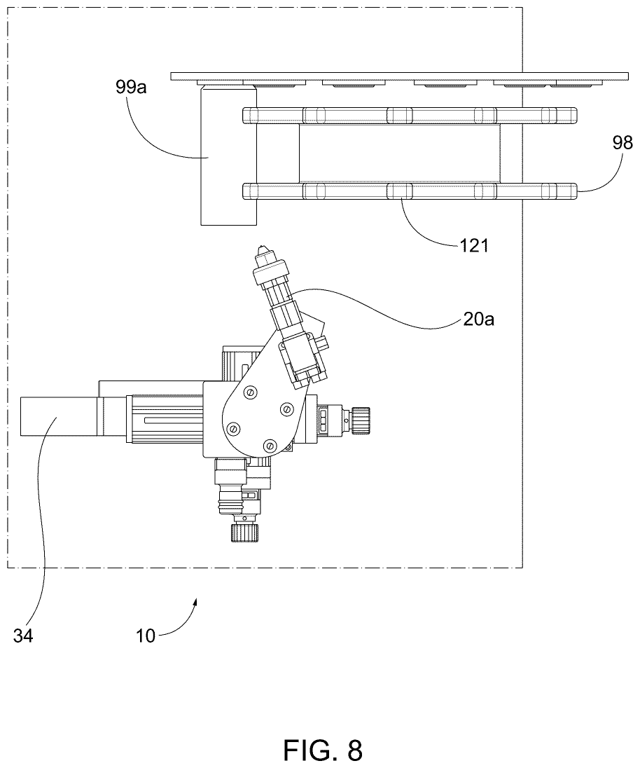

Upon placing a can in position in the pocket 124 of the turret 120, the operator moves the angular alignment mechanism 70a to the desired angle relative to the can centerline, as illustrated in FIG. 8. The desired angle is empirically chosen based on the operator's experience with lacquer spray machines. Determining the desired angle may include trial and error, recommendation from spray gun manufacturers and/or coating manufacturers, and the like.

In the embodiment of the figures, the longitudinal axis of the can is horizontal, thus the spray gun orientation is horizontal both before and after movement of the spray gun via angular alignment mechanism 70a. The horizontal orientation of the spray gun 20a in this regard is not required, as non-horizontal orientations are contemplated depending on the particular parameters of the application.

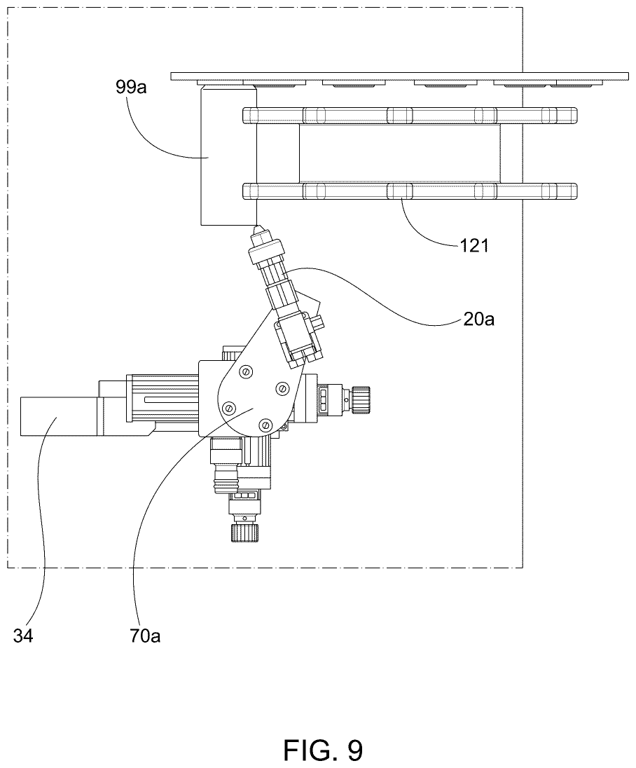

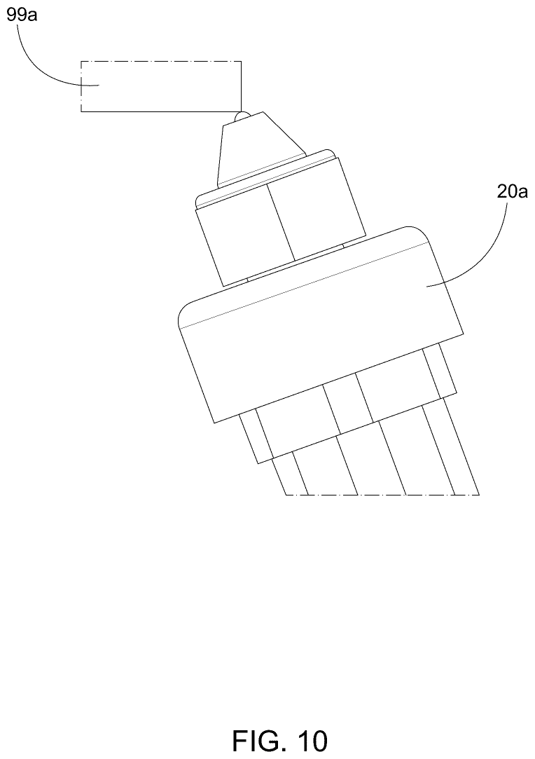

As shown in FIG. 9, upon achieving the desired angular orientation of spray gun 20a, an operator moves the X-direction and Y-direction linear alignment mechanisms 50a and 60a until the tip of the nozzle 22a of the spray gun 20a is just clear of the inner edge of can 99a. FIG. 10 is an enlarged, top view of the relationship of the spray gun 20a tip to the can edge—the nozzle 22a tip is close to the edge of the can but not touching, as the can is easily flexible. The operator zeros-out the digital readouts 58a and 68a of the X-direction and Y-direction linear alignment mechanisms 50a and 60a.

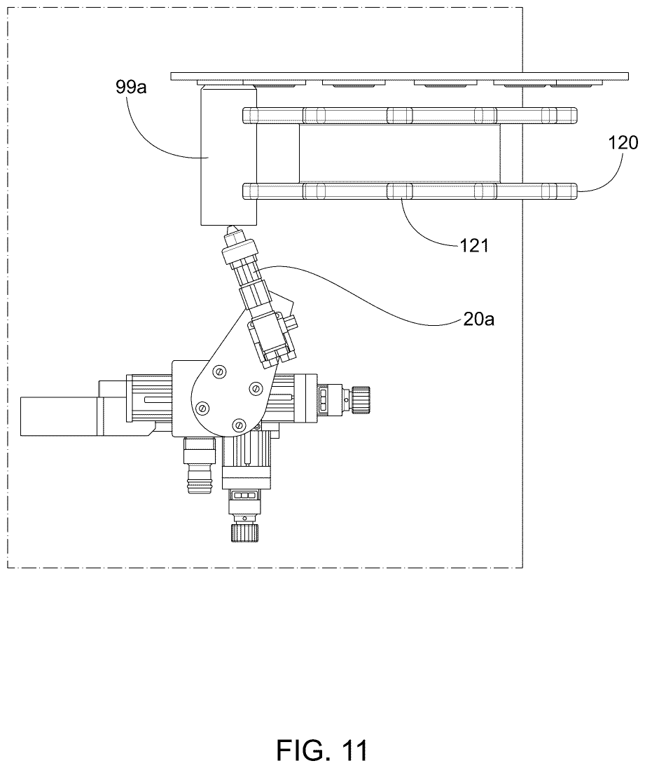

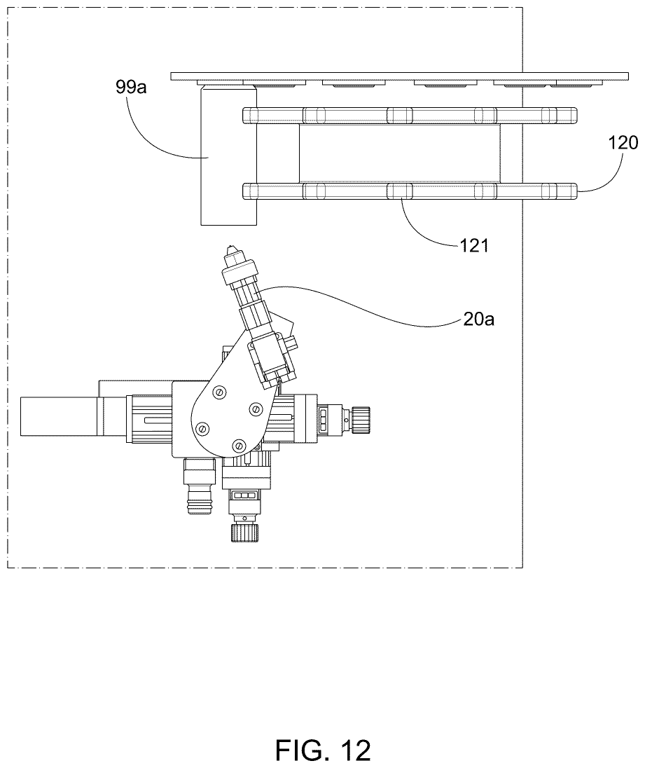

The operator next actuates the Y-direction slider mechanism 52a to position the nozzle 22a at the desired radial position (that is, a position relative to the can longitudinal axis), illustrated in FIG. 11, and records this Y-direction digital readout 58a. Next, the operator actuates the X-direction slider mechanism 62a to position the nozzle 22a to the desired axial position, illustrated in FIG. 12 and records the X-direction readout 68a. Upon recording the linear and angular values, the process-based datum position for the spray gun 20a is set. Upon any movement of the spray gun assembly 20a, such as maintenance to the lacquer spray machine, the position of the spray gun assembly 20a may be reliably reset to its desired position by moving the alignment mechanisms 50a, 60a, and 70a to these pre-determined process-based datum position readouts. Moreover, the readouts may be established for each can version (that is, diameter and height) such that the speed and accuracy of changing the production from one can version to another may be significantly improved. In this regard, the term “pre-determined” as used herein refers to a position or orientation that is the goal of the set-up steps for a particular can version.

It has been encountered that, in some circumstances, that above method is limited by, for example, accurately determining perpendicularity of the spray gun assembly illustrated in FIG. 7. In this regard, the outer profile of some spray gun assemblies may be irregular, making aligning the protractor or straight edge difficult or prone to error; human skill level may introduce variability in alignment; and/or obtaining an unobstructed vertical view may be difficult or infeasible. Furthermore, contact of the spray gun tip with the can, as illustrated in FIGS. 9 and 10, might damage the nozzle spray tip and/or determining the position of the nozzle relative to the can body edge may introduce uncertainty.

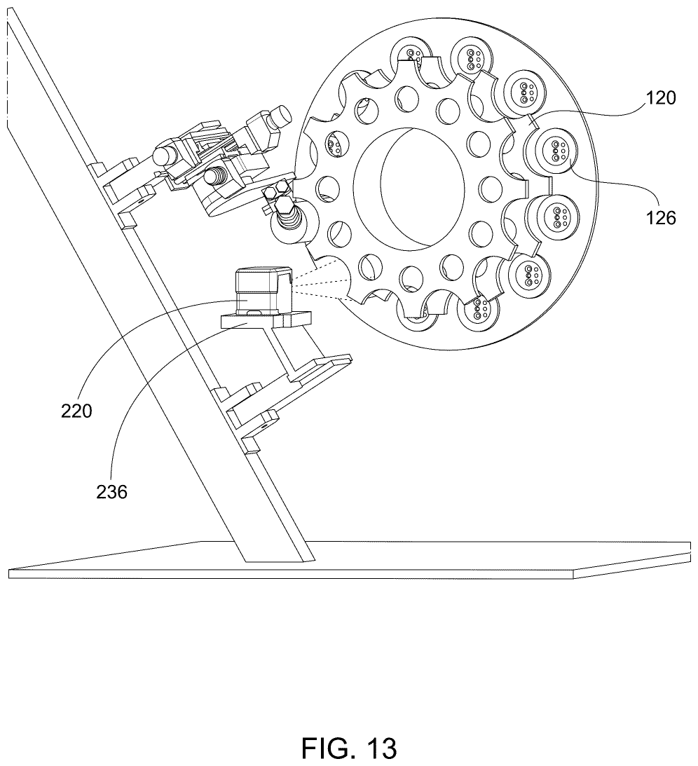

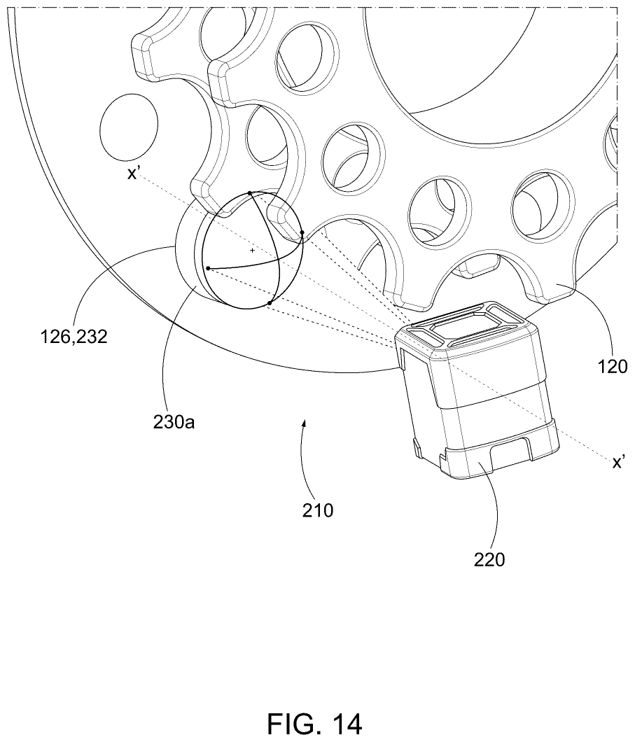

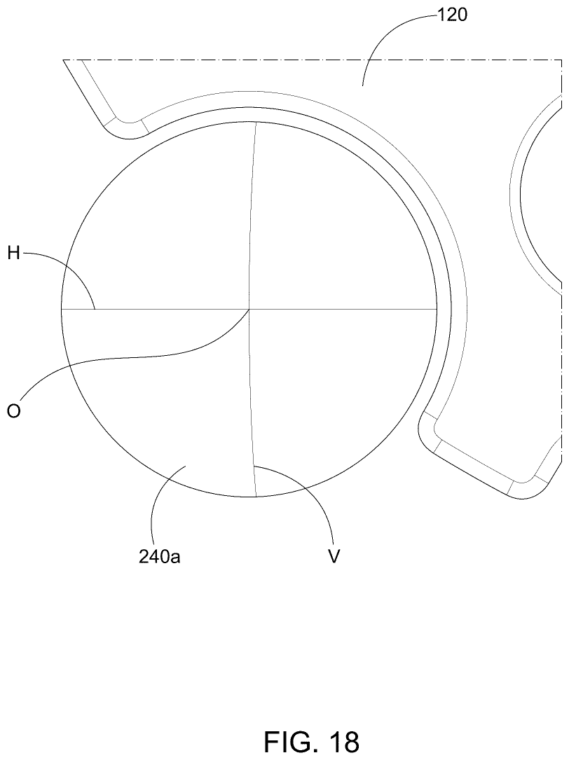

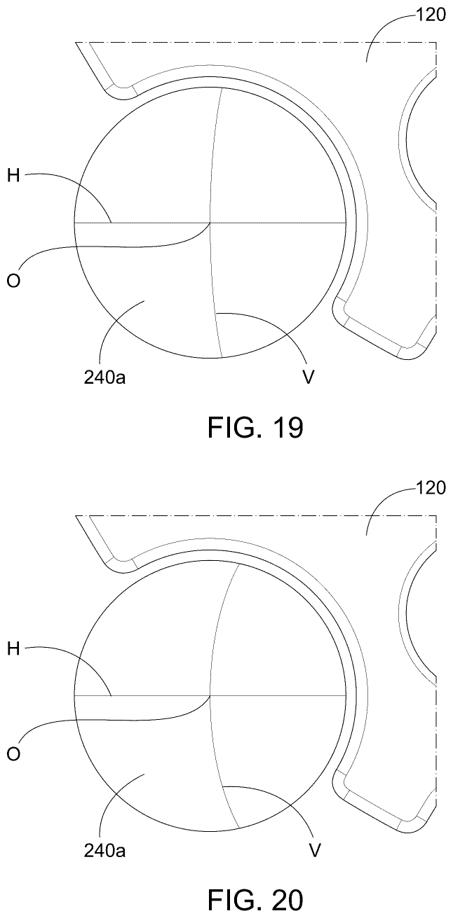

FIGS. 13 through 26 illustrate structures and methods for aligning support rail 34 and corresponding brackets 36a and/or 36b Alignment structure 210 includes a bracket 236, a laser device 220, and a target device. Bracket 236 may be one or both of bracket 36a and 36b, or other bracket structure of known dimension. Laser device 220 may be a conventional laser alignment tool, such as the type having a self-leveling laser that produces a horizontal line H and a vertical line V regardless of the orientation of the device. The alignment structure 210 will be described employing the coordinates including as axis X′ that is defined as parallel to the axis of rotation of the turret and extending through the centerline of chuck 126 and can body 99. Line X′ is illustrated in FIG. 14. The laser device 220 illustrated in the figures is a crosshair. The present invention is not limited to employing a crosshair advice, as explained more fully below.

The target devices illustrated in the figures include a base 232 that engages vacuum chuck 126 or like means for retaining a can body 99. Alternatively, base 232 may be affixed to turret 120 or any other means for affixing the target device; or a portion of the spray machine 110 may perform the function of a base and thus constitute a base.

The target devices include a domed target 230a, a short-neck stepped target 230b, and a long-neck stepped target 230c. Each target device 230a, 230b, and 230c are mounted in registration (that is, repeatable and accurate alignment) with pocket 124 such that the center point C of the target device is aligned with the centerline of a can body 99. In the embodiment of the figures, each target 230a, 230b, and 230c is secured in its corresponding base 232.

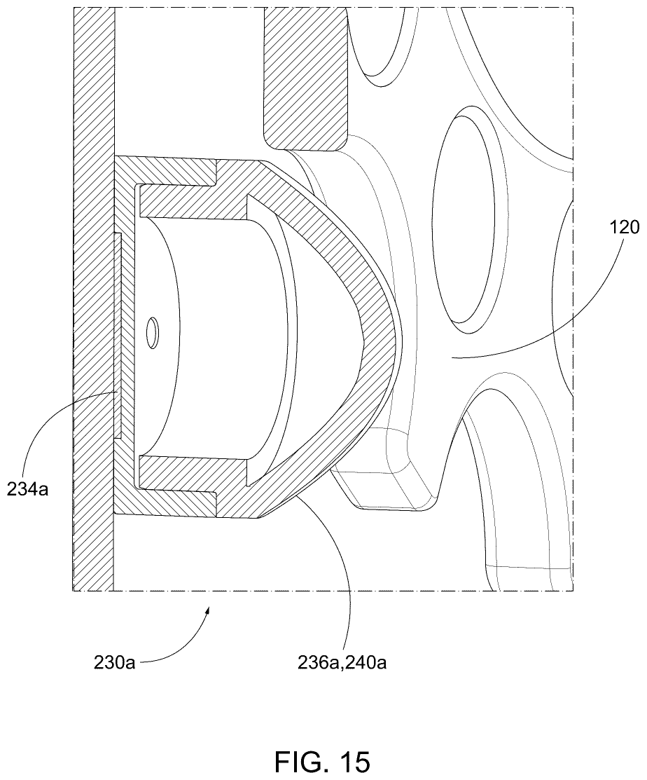

Target device 230a, illustrated in FIG. 15, includes a base 232a and dome 236a that is outwardly convex. Dome 236a includes a face 240a that faces forward (that is, has a face that to which the laser device 120 is directed or visible). Dome 236a may be a hemisphere having a circular cross section (taken in either or both of a vertical and horizontal plane) or have another arcuate shape in cross section. Preferably, dome 236a is symmetrical about both a horizontal plane and a vertical plane. Asymmetrical target devices are contemplated.

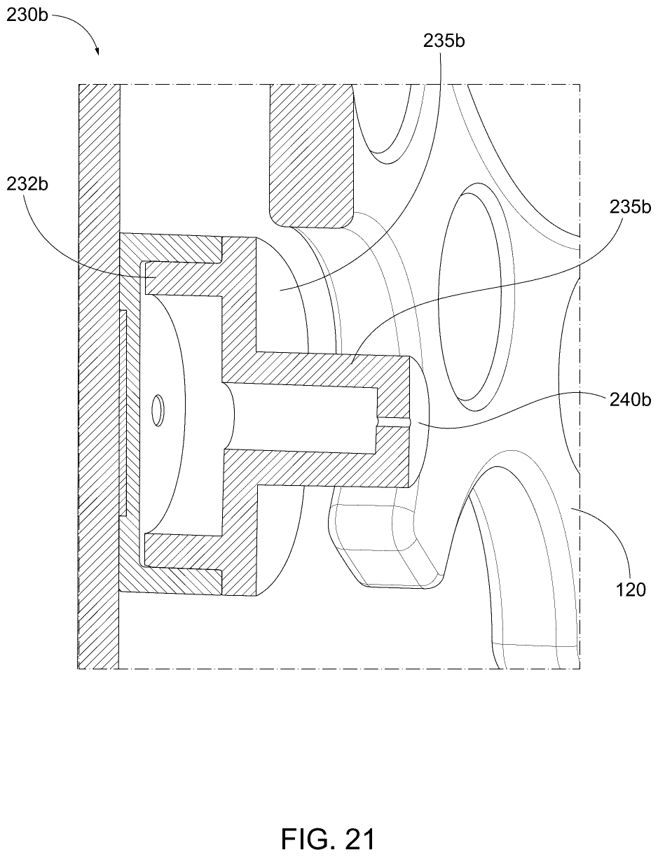

Second embodiment target device, short-necked stepped target 230b illustrated in FIG. 21, includes a base 232b, a base face 235b, a neck 237b, and a front face 240b at the distal end of neck 237b. Base face 235b in the embodiment of the figures is planar and perpendicular to the centerline of can 99 (when in position for spraying). Neck 237b is cylindrical and extends forward relative to base face 235b to end at front face 240b. Front face 240b is planar and perpendicular to the centerline of can 99, and thus parallel to the plane defined by base face 235b In the embodiment of the figures, a center point C of front face 240b is coincident with axis X′.

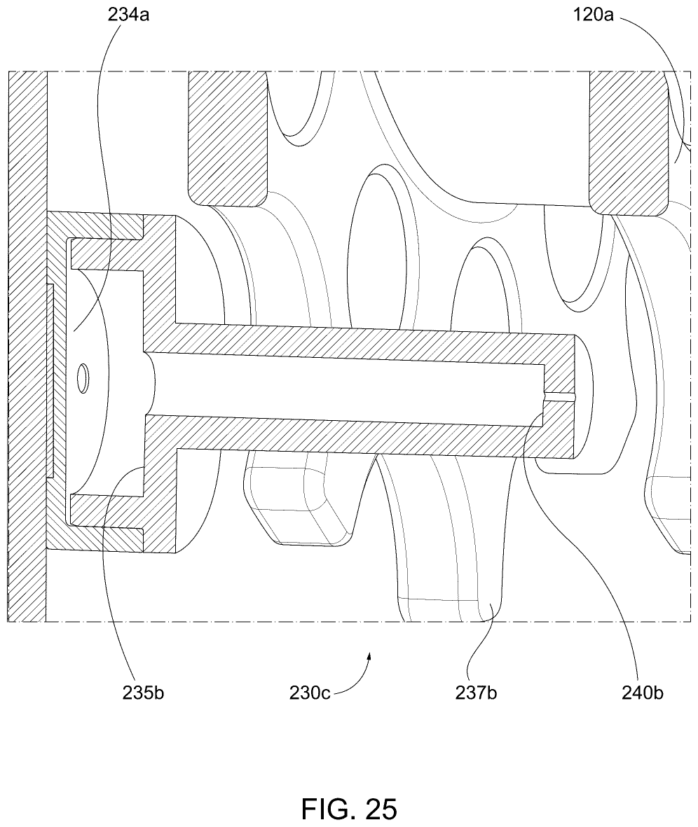

Third embodiment target device, illustrated in FIG. 25, long-necked stepped target 230c, includes a base 232c, a base face 235c, a neck 237c, and a front face 240c at the distal end of neck 237c. Base face 235c in the embodiment of the figures is planar and perpendicular to the centerline of can 99 (when in position for spraying). Neck 237c is cylindrical and extends forward relative to base face 235c to end at front face 240c. Front face 240c is planar and perpendicular to the centerline of can 99, and thus parallel to the plane defined by base face 235c. In the embodiment of the figures, a center point C of front face 240c lies on axis X′.

Long-necked stepped target 230c is functionally similar to short-necked stepped target 230b; the distance between surfaces 235c and 240c is greater than the distance between surfaces 235b and 240b. In other words, third embodiment target device 230c has a longer neck than that of second embodiment target device 230b.

For positioning support rail 34 and/or bracket 36a, 36b, and in this way positioning pre-positioning spray gun assembly 20a and/or 20b, laser device 220 is affixed to bracket 236. The self-aligning feature of laser device 220 produces a horizontal line H and a vertical line V that are pointed toward dome face 240a, as illustrated in FIG. 14. If lines H and V are perfectly linear and mutually orthogonal on dome face 240a, and if their intersection point O is coincident with point C of dome face 240a, then the position in plane Y-Z and the angular relationship of bracket 236 relative to dome 236a is correct, and thus the rail 34 is in appropriate alignment, which alignment will be referred to herein as the “aligned position”.

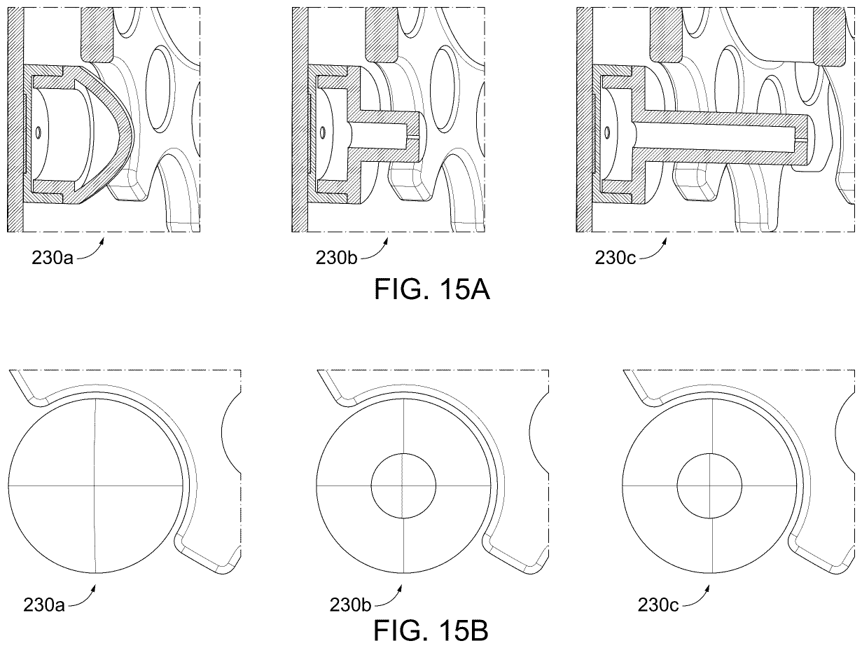

If the intersection O of the crosshairs of laser lines H and V is offset from the center C of the dome face 240a, then laser 220 is not in position relative to axis X′—that is, laser 220 in not in position in the Y-Z plane. Accordingly, the position of bracket 236 may be adjusted in the Y-Z plane toward the aligned position in which the intersection O is on dome face center C. Upon intersection O of the laser crosshair aligning with center C formed on the dome face 240a, then lines H and V may be evaluated for straightness. Any deviation from a straight line of lines H or V indicates an angular misalignment of the laser device 220 relative to dome 236a. FIG. 16 illustrates lines H and V in an angularly aligned position.

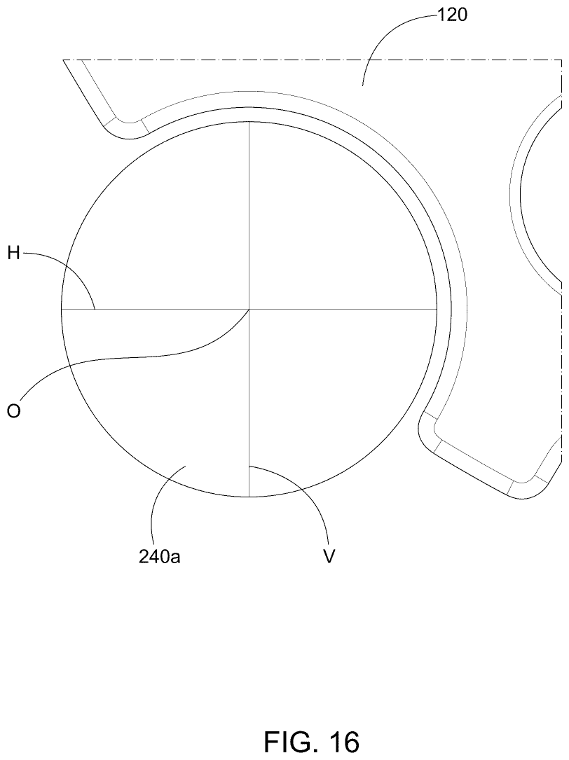

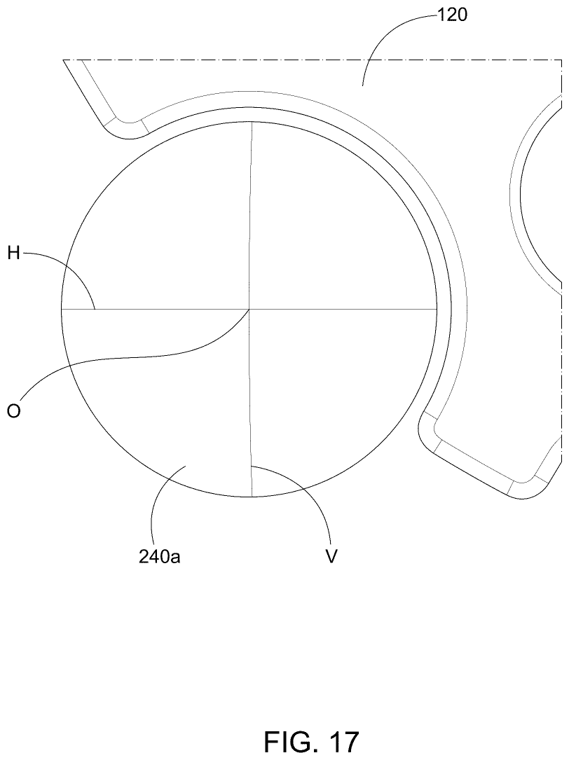

FIG. 17 illustrates line V deviating from a straight and representing a one-degree misalignment of laser device 220 from the axis X′, while points O and C are coincident. FIGS. 18, 19, and 20 illustrate a deviation from linear by line V of two-degrees, five-degrees, and 10-degrees, respectively, illustrating that vertical line V becomes increasingly non-linear with increasing misalignment laser 220 relative to dome 236a about a vertical axis. Thus, the magnitude of deviation from a linear line can be used as an estimate for the magnitude of movement needed of rail 34. It is contemplated that angular movement of laser device 220 may change alignment in the Y-Z plane such that the alignment processes described herein may be iterative.

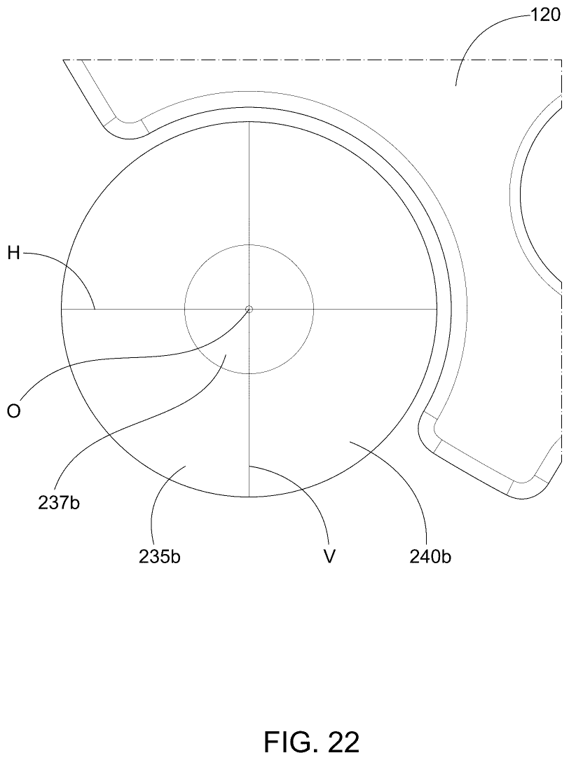

Referring to the second embodiment target device, short-necked stepped target 230b, FIG. 22 illustrates intersection point O of the laser lines H and V being at the center of front face 240b. This coincidence of point O and the center C of front face 240b indicates that laser device 220 (and thus bracket 236) is in proper alignment. The portion H-235b of laser line H hitting base face 235b is aligned with the portion H-240b of laser line H hitting front face 240b. In this regard, lines H-235b and H-240b are aligned when coplanar when viewed as illustrated in FIG. 22, or in three dimensions when lines H-235b and H-240b and axis X′ are coplanar. The portion V-235b of laser line V hitting base face 235b is aligned with the portion V-240b of laser line V hitting front face 240b. Lines V-235b and V-240b are aligned when coplanar when viewed as illustrated in FIG. 22, or in three dimensions when lines V-235b and V-240b and axis X′ are coplanar. Accordingly, FIG. 22 illustrates that laser 220 is in an aligned position relative to short-neck stepped target 230b both in the Y-Z plane and angularly.

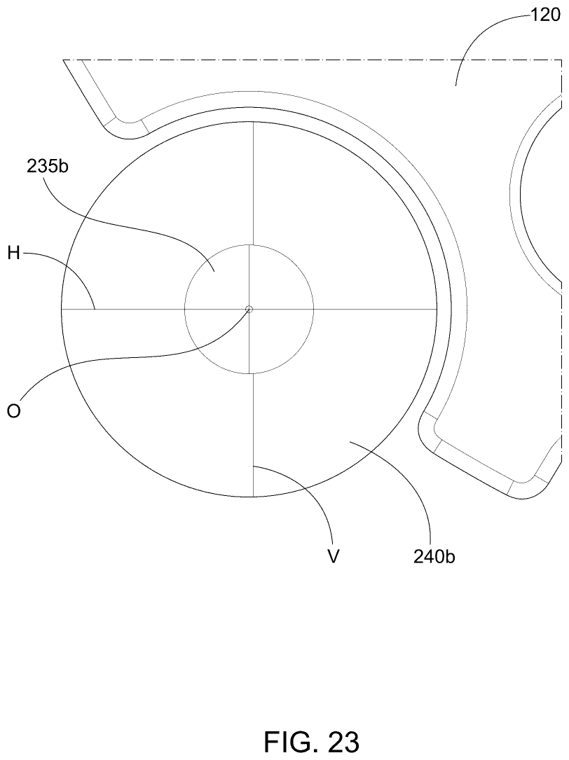

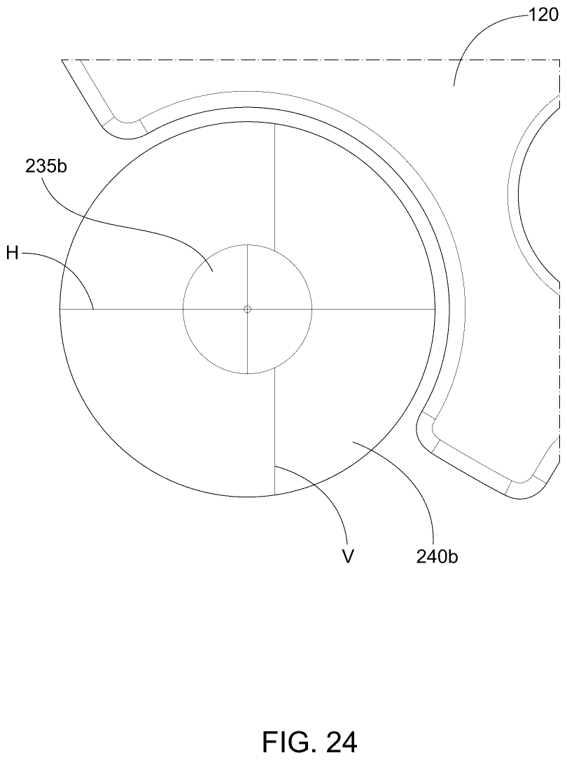

FIG. 23 illustrates that base portion line V-235b is not aligned with line face portion line V-240b, thus indicating an angular misalignment, as is clear from the offset of line V-235b relative to line V-240b. FIG. 23 illustrates a one degree angular misalignment of laser 220 relative to axis X′ as viewed on short-necked stepped target 230b, while intersection O of laser lines H and V is coincident with the center C of front face 240b. FIG. 24 illustrates a 10 degree angular misalignment of laser 220 relative to axis X′, illustrating that vertical line V-235b becomes increasingly displaced relative to line V-240b with increasing misalignment laser 220 relative to axis X. Thus, the magnitude of deviation of lines V-235b and V-240b can be used as an estimate for the magnitude of movement needed of rail 34. It is contemplated that angular movement of laser 220 may change alignment in the Y-Z plane such that the alignment processes described herein may be iterative.

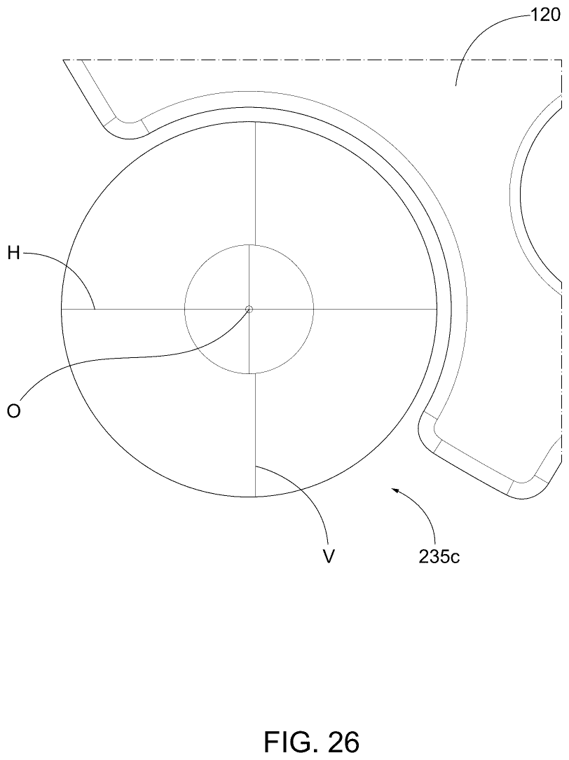

It is understood that the description of the alignment process for long-necked target device 230c will be the same as that for short-necked stepped target 230b, above. The greater neck length of third embodiment device 230c provides more displacement of line V-235c from V-240c compared with the displacement of that described above for second embodiment target device 240b, as illustrated in FIG. 26.

A system for aligning a spray gun of a lacquer spray machine in a can manufacturing line is such that the spray gun may be oriented at an angle relative to the longitudinal axis of the beverage can and the spray gun nozzle adjacent a lip of the beverage can. In this regard, spray system 10 may be employed as described above, with gun mounting plate 76a and spray gun 20a replaced with a datum fixture 320 and a laser device, such as laser device 220 described above. This alignment process is called machine-based datum setting. The advantages are many: machine to machine consistency, setting and resetting consistency on each machine, reduced downtime between can size changes, operator independent spray gun setting (quality improvement), non-contact spray gun setting (reduces nozzle damage), and repeatability of the spray gun location.

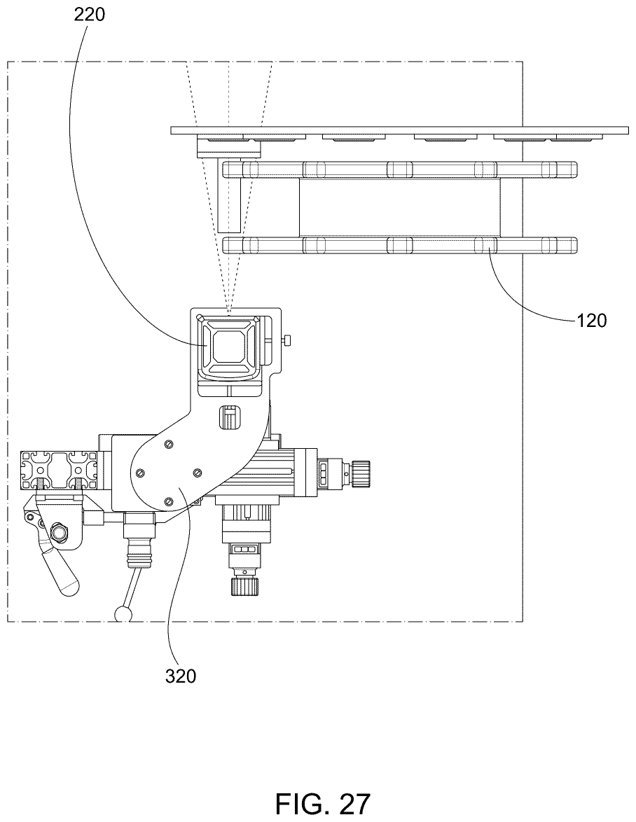

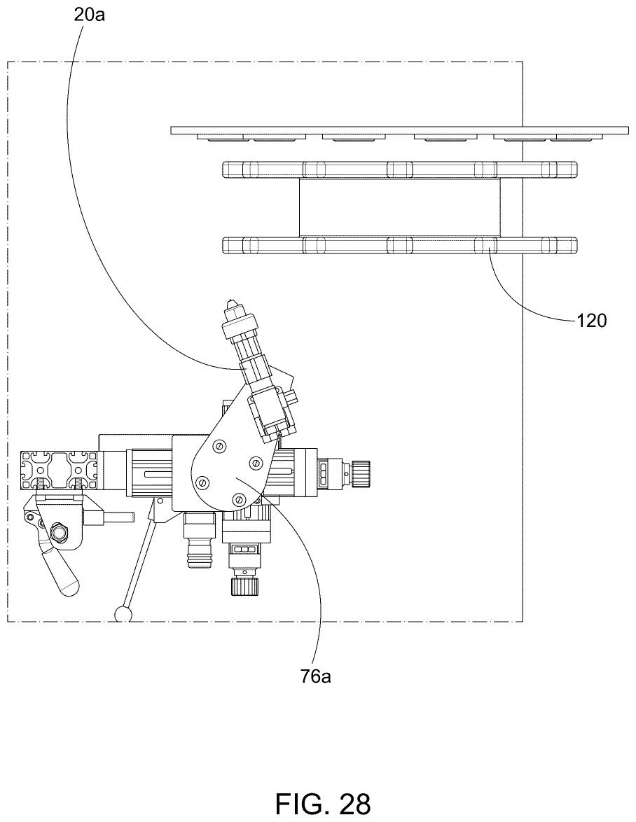

Referring to FIG. 27, datum fixture 320 is sized relative to gun mounting plate 76a such that when laser device 220 is aligned with any one of the target devices described herein, replacing datum fixture 320 with gun mounting plate 76a places spray gun assembly 20a is a desired predetermined position, such as the position illustrated in FIG. 10 in which the spray gun assembly 20a is oriented at an angle relative to the longitudinal axis of the beverage can and the spray gun nozzle 22a adjacent a lip of the beverage can. The adjustment mechanisms may then be zeroed or otherwise set. FIG. 28 illustrates spray gun assembly 20a after datum fixture has been replaced with mounting plate 76a.

The advantages of the machine-based datum setting are numerous: machine to machine consistency within the bank of spray machines, setting and resetting consistency on each machine, reduced downtime between can size changes, operator independent spray gun setting (quality improvement), non-contact spray gun setting (reduces nozzle damage), and repeatability of the spray gun location.

The present invention is disclosed by employing embodiments, which are not intended to be limiting. Rather, the inventors intend that the invention be given the full scope as defined in the claims. Several example embodiments and/or alternatives are provided, and also are not intended to be limiting. Thus, any use of the terms “for example,” “such as,” and any other terms relating to examples ore alternatives do not constitute disclaimer of unnamed structures or functions in any way.

1. A method for repeatably aligning a spray gun of a lacquer spray machine in a can manufacturing line, the method comprising the steps of:
determining an angular orientation of the spray gun corresponding to a desired angular alignment of the spray gun;
determining a linear datum reference point and determining a linear position of the spray gun corresponding to a desired linear alignment of the spray gun; and
recording alignment coordinates of the spray gun relative to the angular orientation and the linear datum reference point;
wherein subsequent alignment of the spray gun is achieved by resetting the spray gun to the recorded alignment coordinates.

2. The method of claim 1 wherein the step of determining the angular direction of the spray gun includes determining a datum reference plane that is perpendicular to a longitudinal axis of a can in position for being spray coated.

3. The method of claim 1, wherein the steps of determining the angular orientation and the linear datum reference point includes the steps of (a) operating the spray gun to spray lacquer on an interior of a can body, (b) assessing characteristics of the lacquer coating on the interior of the can body, (c) adjusting position of the spray gun to improve the characteristics of the lacquer coating, and (d) repeating steps (a) through (c) until a desired alignment is achieved.

4. The method of claim 3, wherein the step of determining the angular direction of the spray gun includes the steps of (e) adjusting angular direction of spray gun.

5. The method of claim 1, further comprising the step of affixing the spray gun to a support in a desired angular direction.

6. The method of claim 1, wherein at least one of the step of determining the linear datum reference point and the step of determining the angular orientation of the spray gun includes adjusting position of the spray gun via alignment screws.

7. A system for repeatably aligning a spray gun of a lacquer spray machine in a can manufacturing line, comprising:
a support structure fixed relative to a base of the lacquer spray machine, the support structure including a spray gun mount;
a spray gun affixed to the spray gun mount;
at least two linear alignment mechanisms adapted for moving the spray gun mount relative to a datum reference point associated with desired alignment of the spray gun; and
an angular alignment mechanism adapted for moving the spray gun mount relative to a desired angular direction of the spray gun;
wherein upon achieving alignment at the datum reference point via iterative operation of the linear alignment mechanisms and the angular alignment mechanism, coordinates of the datum zero point may be recorded to enable subsequent alignment of the spray gun by locating the spray gun mount based on the coordinates.

8. The system of claim 7, wherein the linear alignment mechanisms include at least two linear drives, a first one of the linear drives oriented for translating the spray gun mount in a first direction, a second linear drive oriented for translating the spray gun mount in a second direction that is orthogonal to the first direction.

9. The system of claim 8, wherein the support structure includes a rail that is angled relative to vertical such that the first and second linear drives are capable of positioning the spray gun mount in X-Y-Z coordinates.

10. The system of claim 8, further comprising a third linear drive assembly, wherein the first and second directions define a horizontal X-Y plane and the third linear drive is adapted for translating the spray gun mount in a vertical Z direction.

11. The system of claim 7, wherein each one of the linear drives is a manual linear drive having a display indicating a position of the linear drive, wherein recording of the position from the display at the datum reference point enables subsequent alignment of the spray gun mount by resetting the linear drives to the recording position.

12. The system of claim 7, wherein each one of the linear drives includes an actuator for moving the linear drive, wherein upon determining the datum reference point a control system is adapted for sending a signal to the actuator to position the linear drive at the datum reference point to enable subsequent alignment of the spray gun.

13. The system of claim 7, further comprising an angular alignment mechanism assembly is a manual angular drive having a display indicating angular position of the angular drive, wherein recording of the position from the display enables subsequent alignment of the spray gun mount by resetting the angular drives to the recorded position.

14. A system for aligning a spray gun of a lacquer spray machine in a can manufacturing line, comprising:
a support structure fixed relative to a base of the lacquer spray machine, the support structure including a spray gun mount;
a datum fixture coupled to the spray gun mount;
a laser device affixed to the datum fixture; and
a target device mounted to a predetermined position on the lacquer spray machine, the target device being positioned such that at least one laser line from the laser device impinges on the target device;
whereby the datum fixture and target device are configured to be replaceable with a spray gun fixture and whereby, upon the laser device being aligned with the target device, replacing the datum device with the spray gun fixture and the spray gun positions the spray gun in a desired predetermined position.

15. The system of claim 14, wherein the support structure includes a rail, the laser device being coupled to the rail via a bracket.

16. The system of claim 14, wherein the at least one laser line includes a horizontal laser line and a vertical laser line.

17. The system of claim 16, wherein the target device includes an outwardly convex dome surface adapted to receive impingement of the horizontal laser line and/or impingement of the vertical laser line.

18. The system of claim 17, wherein a deviation from linearity of the horizontal laser line impinging on the dome surface indicates angular misalignment of the laser device relative to the target device and/or a deviation from linearity of the vertical laser line impinging on the dome surface indicates angular misalignment of the laser device relative to the target device.

19. The system of claim 18, wherein the deviation from linearity of the horizontal laser line indicates angular misalignment of the laser device about a horizontal axis and the deviation from the linearity of the vertical laser line indicates angular misalignment of the laser device about a vertical axis.

20. The system of claim 19, wherein a deviation from an intersection of the horizontal laser line and the vertical laser line relative to a center of the dome indicates misalignment of the laser device relative to the dome in a plane perpendicular to an axis of the laser device.

21. The system of claim 16, wherein the target device is a stepped device including a base face, a neck, and a front face; and wherein the neck extending forward relative to the base face such that the front face is formed on a distal end of the neck.

22. The system of claim 21, wherein the front face is planar and the base face is planar and parallel to the front face such that a deviation from co-linearity of the horizontal laser line impinging on the base face relative to the horizontal laser line impinging on the front face indicates angular misalignment of the laser device relative to the target device and/or a deviation from co-linearity of the vertical laser line impinging on the base face relative to the vertical laser line impinging on the front face indicates angular misalignment of the laser device relative to the target device.

23. The system of claim 21, wherein a deviation from an intersection of the horizontal laser line and the vertical laser line relative to a center of the front face indicates misalignment of the laser device relative to the target device in a plane perpendicular to a central axis.

24. A method for aligning a spray gun of a lacquer spray machine in a can manufacturing line, comprising:
impinging at least one laser line from a laser device on a target device that is positioned to receive impingement of the at least one laser line;
adjusting position of a support structure holding the laser device based on linearity of the at least one laser line, and/or based on deviation of a center of the laser line,
determining a datum reference point and determining an angular direction of the spray gun such that desired alignment of the spray gun is achieved; and
recording alignment coordinates of at least the datum reference point;
wherein subsequent alignment of the spray gun is achieved by resetting the spray gun to the alignment coordinates associated with the datum reference point.

25. The method of claim 24, wherein the support structure includes a rail, and wherein the step of adjusting position of the support structure including moving the rail and/or moving a bracket supported by the rails.

26. The method of claim 24, wherein the step of impinging at least one laser line includes impinging a horizontal laser line and a vertical laser line on the target device.

27. The method of claim 26, wherein the target device includes an outwardly convex dome surface, and the step of impinging step at least one laser line includes impinging the horizontal laser line and/or impinging of the vertical laser line on the dome surface.

28. The method of claim 27, wherein a deviation from linearity of the horizontal laser line impinging on the dome surface indicates angular misalignment of the laser device relative to the target device and/or a deviation from linearity of the vertical laser line impinging on the dome surface indicates angular misalignment of the laser device relative to the target device.

29. The method of claim 28, wherein the deviation from linearity of the horizontal laser line indicates angular misalignment of the laser device about a horizontal axis and the deviation from the linearity of the vertical laser line indicates angular misalignment of the laser device.

30. The method of claim 27, wherein a deviation from an intersection of the horizontal laser line and the vertical laser line relative to a center of the dome indicates misalignment of the laser device relative to the dome in a plane perpendicular to a central.

31. The method of claim 26, wherein the target device is a stepped device including a base face, a neck, and a front face; and the neck extending forward relative to the base face such that the front face is formed on a distal end of the neck.

32. The method of claim 31, wherein the front face is planar and the base face is planar and parallel to the front face such that a deviation from co-linearity of the horizontal laser line impinging on the base face relative to the horizontal laser line impinging on the front face indicates angular misalignment of the laser device relative to the target device and/or a deviation from co-linearity of the vertical laser line impinging on the base face relative to the vertical laser line impinging on the front face indicates angular misalignment of the laser device relative to the target device.

33. The method of claim 31, wherein a deviation from an intersection of the horizontal laser line and the vertical laser line relative to a center of the front face indicates misalignment of the laser device relative to the target device in a plane perpendicular to a central axis.
